(19) United States
(12) Patent Application Publication
(10) Pub. No.: US 2009/0094168 A1
(43) Pub. Date: Apr. 9, 2009

(54) SYSTEM AND METHOD OF PROVIDING A LONGEVITY BENEFIT

(76) Inventors: Philip Konrad Polkinghorn, Simsbury, CT (US); Katherine Preli Cody, South Glastonbury, CT (US); Zafar Rashid, Avon, CT (US); John Vincent LaGrasse, Nashville, TN (US); Michael Alan Donovan, JR., South Windsor, CT (US); Laurie Diane Lewis, West Hartford, CT (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/238,142

(22) Filed: Sep. 25, 2008

Related U.S. Application Data
(60) Provisional application No. 61/041,510, filed on Apr. 1, 2008.
(60) Provisional application No. 60/977,247, filed on Oct. 3, 2007.

(51) Int. Cl. G06Q 40/00

(52) U.S. Cl. 705/36 R

(57) ABSTRACT

Systems and methods are provided for providing enhanced late-life retirement income through the issuance of credits to a financial instrument. With these credits, the individuals have the potential for a higher return late in life in exchange for potential forfeiture of at least a portion of the designated account for premature death.

### CROSS REFERENCE TO RELATED APPLICATIONS

This application claims benefit of and priority to U.S. Provisional Application Ser. No. 61/041,510, filed Apr. 1, 2008, and U.S. Provisional Patent Application Ser. No. 60/977,247, filed Oct. 3, 2007, both of which are fully incorporated herein by reference and made a part hereof.

### BACKGROUND

The system and methods described herein generally pertain to providing a longevity benefit that can be attached to a financial instrument, such as an annuity, mutual fund or other financial asset or account.

Today, with increasing life expectancies and concurrent increases in the cost of living and inflation, it is difficult to plan for longevity. For instance, in the United States, life expectancy increased dramatically in the twentieth century. Life expectancy at birth in the United States in 1900 was forty-seven (47) years. At the end of the century it was seventy-seven (77) years, an increase of sixty-four percent (64%) (or an increase of thirty (30) years). Similar gains have been seen throughout the world. Life expectancy in China was around thirty-five (35) years in 1950. At the century's close it had risen to around seventy-one (71) years. Life expectancy in India at mid-century was around thirty-two (32); by 2000 it had risen to sixty-four (64) years. Furthermore, because of market volatility, it is generally not possible for any particular individual to consistently or effectively allocate assets in a way to mitigate longevity volatility for that individual.

Recent studies have indicated that approximately one-third of retirees are concerned about outliving their retirement savings, but sixty-one percent (61%) admitted they have not made a formal calculation of how much they can afford to spend monthly to prevent doing so. However, research has found that pre-retirees believe they will need to make their retirement savings last until an average of age eighty-three (83), yet estimates today give a healthy sixty-five (65) year-old man a thirty-four percent (34%) chance of living to at least ninety (90) and healthy women a forty-six percent (46%) chance of living to ninety (90).

As long as gains in life expectancy are foreseeable and are taken into account when planning retirement, these gains should have a negligible net effect on retirement finances. Unfortunately, for any particular person, improvements in mortality and life expectancy are unknown and uncertain. In this regard, longevity risk is associated with the risk that, for any particular individual, future mortality and life expectancy outcomes turn out different than expected. Furthermore, while life expectancy may be estimated for large groups of people with some degree of accuracy, an individual may ultimately experience a life expectancy much longer or shorter than expected for the age cohort as a group. As a result of this uncertainty surrounding an individual's actual mortality, retirees who assume that they will not survive to old age run the risk of outliving their resources and being forced to reduce their standard of living at old ages or rely upon other income sources, such as family or government programs. In this context, individuals bear the full extent of the longevity risk when this risk is “uncovered.” Individuals often try to manage their finances in order to self-insure for longevity risk, but may find that late in life (e.g., after eighty-five (85) years of age), unanticipated retirement funds are needed. The fear of running out of assets late in life may have a negative emotional impact on the quality of early retirement as the individual lives with continual financial uncertainty.

Financially protecting against the longevity risk of individuals is generally referred to as longevity protection, which can be very valuable and useful. Currently, the most common insured means or package, outside of the employer or government context, in which to get longevity protection, is a traditional payout annuity, but traditional annuities are not the ideal solution for all individuals.

With a traditional annuity, an investor invests a portion of his or her assets and uses the annuity payment as a primary source of income. However, under this scenario, a financial risk is posed to heirs if the investor experiences a premature death without a death benefit under the annuity. Further, some traditional annuities have little liquidity. While the annuity can serve as a vehicle for protecting against longevity risk for some individuals, for others it is too limiting, especially in the early years of retirement. Without an annuity, an investor manages his or her retirement investments based on one's own estimate of life expectancy. If the investor lives longer than anticipated or has expenses greater than anticipated, the retirement assets may be prematurely exhausted or depleted without any means for obtaining additional assets at an older age.

Therefore, what is needed is an alternative to traditional annuities for protecting against longevity risk that overcomes many of the challenges found in the art, some of which are described above. This alternative can come in the form of a vehicle that also allows an investor to obtain additional retirement assets should the individual survive to an advanced age.

### SUMMARY

In various embodiments, systems and methods are described that provide an investor with additional resources to produce assets or income above the performance of a financial instrument if the investor lives to an advanced age, such as for example eighty-five (85) or ninety (90) years of age. Embodiments help protect against not having sufficient financial resources for individuals living longer than expected, while addressing some of the challenges presented in traditional annuities. Embodiments according to the present invention require a relatively small amount of capital to ensure sufficient funds to mitigate long term financial longevity risk.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the scope of the invention.

### DRAWINGS

The accompanying drawings, which are incorporated in and constitute a part of this specification, illustrate certain aspects of the instant invention and together with the description, serve to explain, without limitation, the principles of the invention and like reference characters used therein indicate like parts throughout the several drawings:

FIG. 1 shows a block diagram of a system for issuing a longevity benefit in accordance with various embodiments of the present invention;

FIG. 2 shows an exemplary schematic diagram of the receiving computer 112 according to one embodiment of the invention;

FIG. 3 shows an exemplary schematic diagram of the computing device 108 according to one embodiment of the invention;

FIG. 4 is an illustration of an exemplary embodiment of a process according to the present invention;

FIG. 5 is an illustration of an exemplary embodiment of another process according to the present invention;

FIG. 6 is an illustration of an exemplary embodiment of a third process according to the present invention;

FIG. 7 is an illustration of an exemplary embodiment of a fourth process according to the present invention;

FIG. 8 illustrates the steps taken when issuing a longevity benefit according to one embodiment of the present invention; and

FIGS. 9A and 9B illustrate growth of an investment with the longevity benefit—FIG. 9A illustrates the growth with credits in tabular form, and FIG. 9B illustrates the growth in graphical form.

### DETAILED DESCRIPTION

The embodiments described herein may be understood more readily by reference to the following detailed description and the examples included therein and to the figures and their previous and following description.

Before the present systems, articles, devices, and/or methods are disclosed and described, it is to be understood that this invention is not limited to specific systems, specific devices, or to particular methodology, as such may, of course, vary. It is also to be understood that the terminology used herein is for the purpose of describing particular embodiments only and is not intended to be limiting.

The following description is provided as an enabling teaching of the invention in its best, currently known embodiments. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used in the specification and the appended claims, the singular forms “a,” “an” and “the” include plural referents unless the context clearly dictates otherwise. Thus, for example, reference to “a reflector” includes two or more such reflectors, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as the “greater than or equal to 10” is also disclosed. It is also understood that throughout the application, data is provided in a number of different formats and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

“Optional” or “optionally” means that the subsequently described event or circumstance may or may not occur, and that the description includes instances where said event or circumstance occurs and instances where it does not.

“Exemplary,” where used herein, means “an example of” and is not intended to convey a preferred or ideal embodiment. Further, the phrase “such as” as used herein is not intended to be restrictive in any sense, but is merely explanatory and is used to indicate that the recited items are just examples of what is covered by that provision.

As will be appreciated by one skilled in the art, embodiments can comprise a method, a data processing system, or a computer program product. Accordingly, the aspects described herein can take the form of an entirely hardware embodiment, an entirely software embodiment, or an embodiment combining software and hardware aspects. Furthermore, aspects described herein can take the form of a computer program product on a computer-readable storage medium having computer-readable program instructions (e.g., computer software) embodied in the storage medium. More particularly, aspects can take the form of web-implemented computer software. Any suitable computer-readable storage medium may be utilized including hard disks, CD-ROMs, optical storage devices, or magnetic storage devices.

Embodiments are described below with reference to block diagrams and flowchart illustrations of methods, apparatuses (i.e., systems) and computer program products. It is to be appreciated that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Overview

Embodiments described herein provide an investor with an option that overcomes many of the financial disadvantages associated with the risk of outliving retirement assets. Accordingly, in one aspect an investor designates some portion of his or her assets to have a longevity benefit. In one aspect, these assets are liquidated and the proceeds are invested in an annuity with particular longevity features. In another aspect, the designated assets are placed in a specially noted account to which a financial institution (including an insurance company) has access for deposits and has a right to survivorship. It is to be appreciated, however, that to practice aspects according to the present invention, the assets do not require physical placement into a secure account and may be designated as all or a portion of an investor's existing account. The assets can generally be invested in a traditional investment product, such as mutual funds, managed accounts, stocks, bonds, insurance, etc.

In an aspect, when the longevity benefit is elected, the investor selects a deferral period, which ends at an advanced age of the investor's choice, typically eighty to ninety (80-90) years of age. During the deferral period, while the investor is alive, a credit is periodically applied to the underlying assets or account value designated under the longevity benefit. In one aspect, the credit can be a set amount of money added to the account that can be invested pursuant to the plans of the investor, though other forms of a credit are contemplated within the scope of the invention, such as a percentage multiplier of the underlying assets, etc. In one aspect, the credit increases with age. For example, the credit could be a percentage of the account balance that escalates over the deferral period. The credits could occur annually, semi-annually, monthly, every five (5) years, or any other periodic basis or portion of the deferral period. At the end of the deferral period, and if the investor is still alive, the account balance will be substantially greater than it would have been if invested without the longevity benefit. This is because of the credit increase to the account value and the investment return on the additional credited monies. In another aspect, there may be two (2) investors, where only one (1) investor needs to be alive at the end of the deferral period in order to receive benefits. In exchange for the added credit, the account balance or a portion of the account balance is not accessible during the deferral period and the account balance or a portion of it is payable over to the financial institution upon death of the investor if it occurs before the end of the deferral period.

At the end of the deferral period, the investor has the option of electing an additional deferral period; taking the entire account balance, or any portion of it, as a lump sum withdrawal; begin taking systematic withdrawals from the account, including maintaining the flexibility to transfer remaining assets, start and stop income, or cash out at a later date; or to purchase an immediate or deferred annuity with the amount. In one aspect, the longevity benefit may be taxed as an equity investment and in a different aspect, the benefit may be taxed as an annuity. In one aspect, there may be a guarantee as to a minimum account balance at the end of the deferral period or a minimum income amount that can be received on a periodic basis after the deferral period has ended.

Advantages of the longevity benefit include an investor having to allocate only a relatively small portion of their assets to the longevity benefit while having the remaining assets freely available for current retirement expenses; and reduced anxiety about out-living retirement savings. Table I, below, compares the longevity benefit to traditional payout annuities.

TABLE I

| Life-Contingent Payout Annuities | Longevity Benefit |
|---|---|
| Investor typically invests a large portion of | Investor is designating only a small |
| his or her assets and uses the periodic | portion of his or her assets, while the other |
| payments as the primary source of income | retirement assets are managed separately |
| | by the investor |
| Payments begin within one year of | Payments begin only at the advanced age |
| purchase, even though the investor may not | selected by the investor |
| need the annuity payouts at that time | |
| If a fixed annuity, investor's money gets | Investor get to choose his or her |
| invested in the insurance company's | underlying investment strategy to the |
| general account | extent permitted by law |
| If an annuity, fees are assessed against the | The fees assessed, if any, are currently |
| investor's underlying funds | designed to be minimal |
| For a fixed annuity, tends to be a “black | Provides transparency to the investor |
| box” from the investor's standpoint | |
| Investor's heirs may or may not be entitled | In exchange for protection under the |
| to a benefit upon the premature death of | longevity benefit, investor is taking the |
| the investor. The existence of a death | risk of dying early, with no or limited |
| benefit acts to reduce the lifetime benefits | amounts (including original investment) |
| available under the contract | payable to heirs should the investor die |
| | before the end of the deferral period |

Provides protection against the investor outliving their assets

### System for Issuing and Administering a Longevity Benefit

### System Architecture

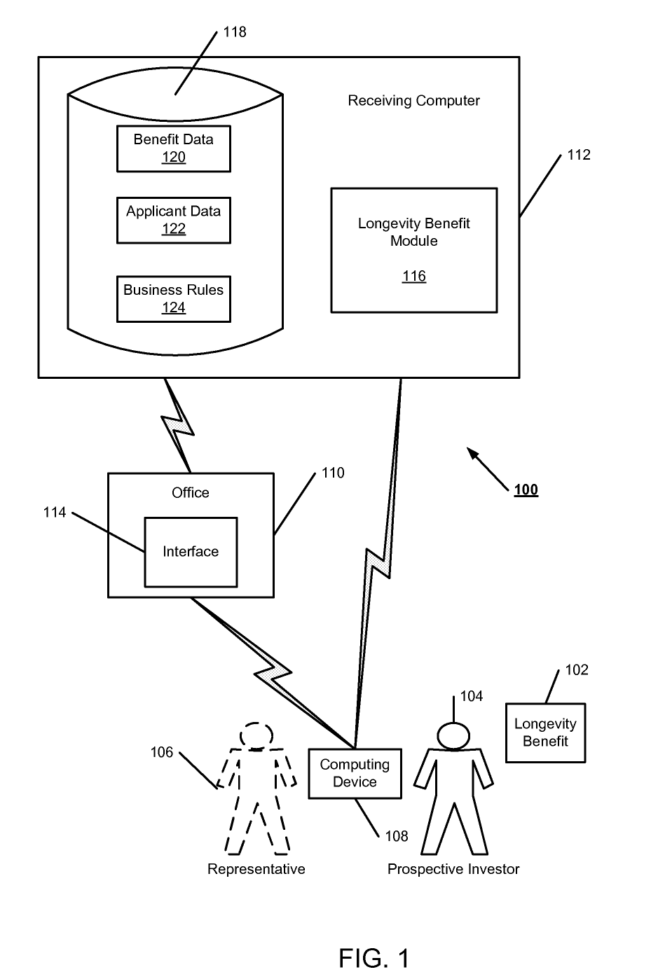

FIG. 1 shows a block diagram of a system for issuing a longevity benefit 102 in accordance with various embodiments described herein. As may be understood from this figure, the system 100 can include a prospective investor 104 in contact with a representative from the issuer of the longevity benefit 106 having access to a computing device 108, into which the representative 106 can enter participant data received from the prospective investor 104 or other sources regarding the longevity benefit. As can be appreciated by one of ordinary skill in the art, the computing device 108 can be any type of computing device, including, for example, a mobile telephone, personal data assistant (PDA), laptop or mobile personal computer (PC), desktop unit, or workstation.

The system further includes an office 110 in communication with the computing device 108, and a receiving computer 112 in communication with the office 110. The office 110, which may be operated directly by the receiving company or by some other entity affiliated with the receiving company, includes at least an interface 114 to facilitate the communication of applicant data between the computing device 108 and the receiving company computer 112. The interface 114 can be any known interface including, for example, a docking station that is connected to an IT infrastructure, such as a Local Area Network (LAN), Wide Area Network (WAN), or the Internet. Data can, therefore, be communicated from the office 110 to the receiving company computer 112 via any known means of communicating data including, for example, via the Internet, via a cable connection, by fax, via a telephone network, or even by a human operator located at the office 110.

Alternatively, the computing device 108 can be configured to communicate with the receiving company computer 112 directly without the need for an office 110 and the interface 114. The computing device 108 can communicate with the receiving company computer 112 via a communications network such as the Internet, WAN, one or more LANs, wireless network, cellular network, etc.

The receiving company computer 112 includes at least a longevity benefit module 116. The module 116 can be configured to retrieve data from, and store data to, one or more databases 118. As shown, benefit data 120, which can include data about the longevity benefit, applicant data 122 and business rules 124 can each be stored in the database 118 and accessed by the longevity benefit module 116.

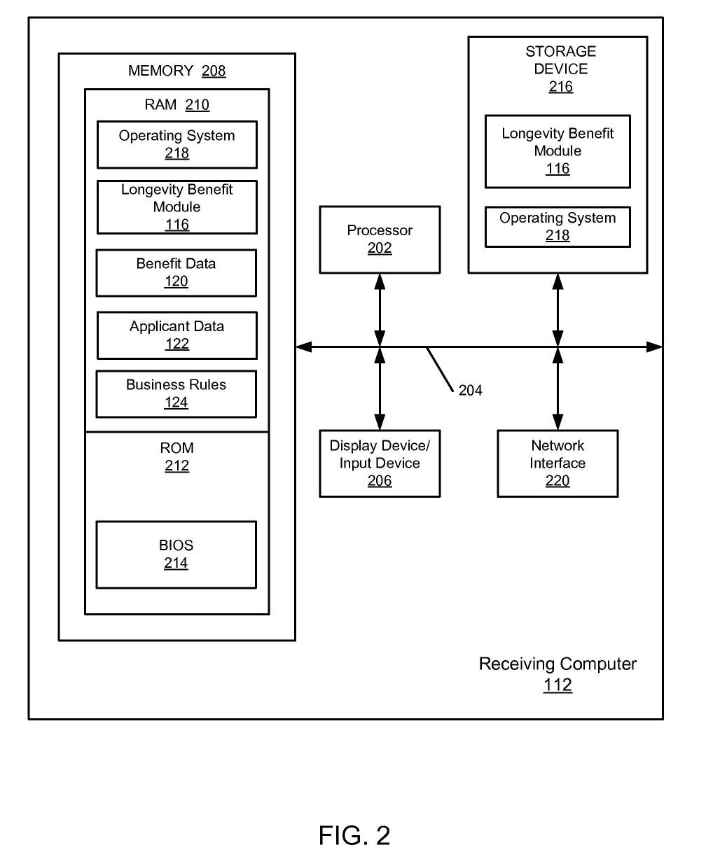

FIG. 2 shows an exemplary schematic diagram of the receiving computer 112 that can be used to practice various aspects as described herein. The receiving computer 112 includes a processor 202 that communicates with other elements within the receiving computer 112 via a system interface or bus 204. The processor 202 could be, for example, a central processing unit, microprocessor, microcontroller, programmable gate array, or some other device that processes data. Also included in the receiving computer 112 is a display device/input device 206 for receiving and displaying data. The unit 206 can include, for example, an input device such as a keyboard, mouse or pointing device, and a display device such as a monitor, cathode ray tube (CRT), liquid crystal display (LCD), or other such device. The receiving computer 112 further includes a memory 208, which includes both random access memory (RAM) 210 and read only memory (ROM) 212. The computer's ROM 212 is used to store a basic input/output system 214 (BIOS), containing the basic routines that help to transfer information between elements within the receiving computer 112. The computer's RAM 210 is used to store the benefit data 120, applicant data 122 and business rules 124.

In addition, the receiving computer 112 can include at least one storage device 216, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 216 is connected to the system bus 204 by an appropriate interface. The storage devices 216 and their associated computer-readable media provide nonvolatile storage for a personal computer. It is to be appreciated that the computer-readable media described above could be replaced by any other type of computer-readable media known in the art. Such media include, for example, magnetic cassettes, flash memory cards, digital versatile disks, Bernoulli cartridges, etc.

A number of program modules may be stored by the various storage devices 216 and within RAM 210. Such program modules include an operating system 218, and the longevity benefit module 116. The longevity benefit module 116 controls certain aspects of the operation of the receiving computer 112, as is described in more detail below, with the assistance of the processor 202 and the operating system 218.

Also located within the receiving computer 112 is a network interface 220, for interfacing and communicating with other elements of a computer network. It will be appreciated by one of ordinary skill in the art that one or more of the receiving computer 112 components may be located geographically remotely from other receiving computer 112 components. Furthermore, one or more of the components may be combined, and additional components performing functions described herein may be included in the receiving computer 112.

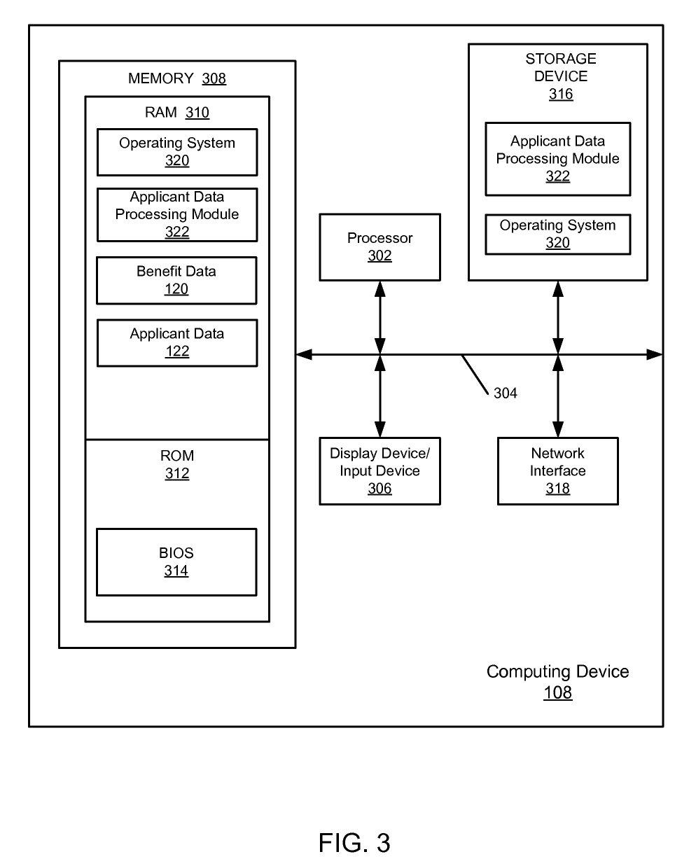

FIG. 3 shows an exemplary schematic diagram of the computing device 108 that can be used to practice various aspects, as described herein. The computing device can be used by the prospective investor 104 or the representative 106, or both, to receive applicant data and to transfer the same to the receiving computer 112. The elements of the computing device 108 shown in FIG. 3 are the same or similar to corresponding elements of the receiving computer 112 shown in FIG. 2, with a few exceptions. In particular, the computing device 108 includes a processor 302 that communicates with other elements within the computing device 108 via a system interface or bus 304, a display device/input device 306 for receiving and displaying data, a memory 308, which includes both random access memory (RAM) 310 and read only memory (ROM) 312, wherein the ROM 312 is used to store a basic input/output system 314 (BIOS) and the RAM 312 is used to at least temporarily store benefit data 120 and applicant data 122, at least one storage device 316, and a network interface 318, for interfacing and communicating with other elements of a computer network.

Like the receiving computer 112, a number of program modules can be stored by the various storage devices 316 and within RAM 308. Such program modules include an operating system 320, and an applicant data processing module 322. The applicant data processing module 322 controls certain aspects of the operation of the computing device 108, as is described in more detail below, with the assistance of the processor 302 and the operating system 320.

### Method of Administering a Longevity Benefit

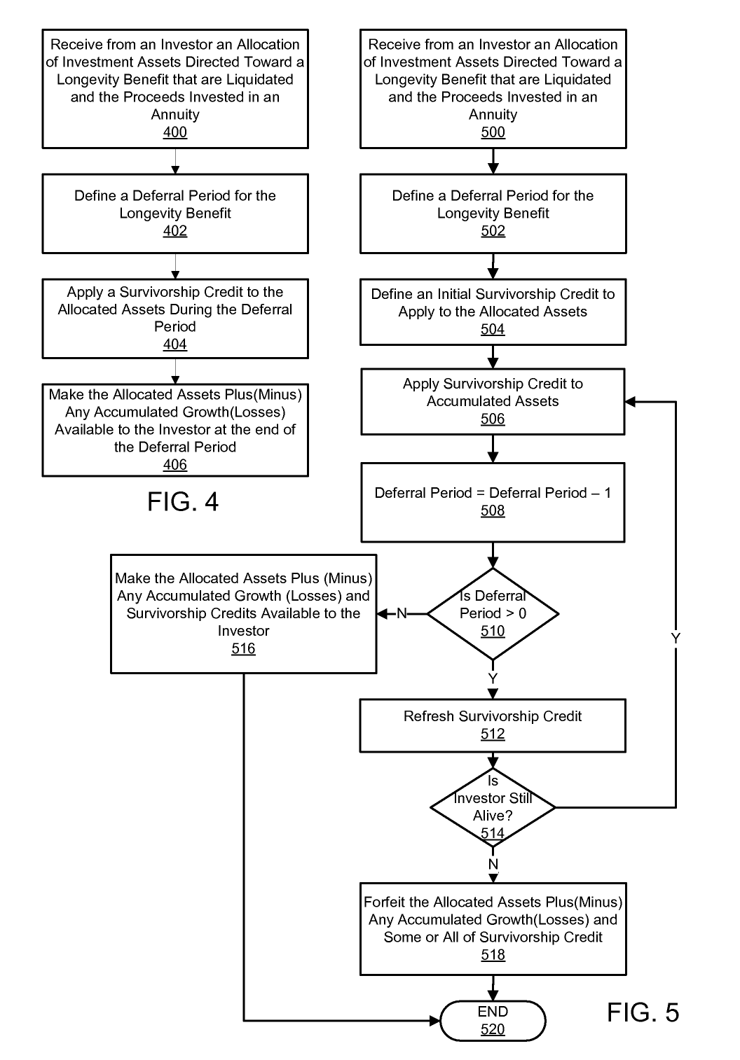

FIG. 4 is an illustration of an exemplary embodiment of a process that can be implemented and carried out on one or more computing devices. At step 400, an allocation of investment assets toward a longevity benefit are liquidated and the proceeds are invested in an annuity. Information about the annuity can be designated in a memory associated with a computing device. At step 402, a deferral period is defined for the longevity benefit. For example, a sixty-five (65) year old investor may desire a deferral period of twenty (20) years, so that the investor will have funds available at age eighty-five (85) if he or she survives to that age. Other deferral periods may be available and may be as short as one (1) year and as long as fifty (50) years. At step 404, a survivorship credit is applied to the allocated assets during the deferral period. The credit is above and beyond the investment return on the allocated assets from the underlying assets. For example, the credit can be a percentage of the allocated assets, or could even be a lump sum contributed to the allocated assets on a periodic or one-time basis during the deferral period. In one instance, for example, the credit increases each year of the deferral period. As an example, assume that the underlying investment allocated to the longevity benefit earns a 10 percent annualized return—the credit could be an additional one-tenth of one percent (0.1%) in addition to the ten percent (10%) annualized return. In one aspect, the credit can escalate each year of the deferral period (e.g., one-tenth of one percent (0.1%) the first year, two-tenths of one percent (0.2%) the second year, three-tenths of one percent (0.3%) the third year, etc.). At step 406, the accumulated assets, which include the annuity purchased with the initially allocated assets plus (or minus) any investment growth (or losses), plus the credit growth of the investment are made available to the investor. As previously described herein, the investor can receive these funds as a lump sum, a partial lump sum, on a periodic basis, as a payout annuity, etc.

FIG. 5 is an illustration of an exemplary embodiment of another process that can be implemented and carried out on one or more computing devices. At step 500, there is an allocation of investment assets toward a longevity benefit. The longevity benefit structure can be designated in a memory associated with a computing device. At step 502, a deferral period is defined for the longevity benefit. At step 504, an initial survivorship credit is defined for the allocated assets to be applied during the first year (or initial sub-period) of the deferral period. As previously described, the credit is above and beyond the investment return on the allocated assets from the underlying assets. At step 506, the credit is applied to the allocated assets and any ensuing growth (or loss) of the accumulated assets. At step 508, the deferral period is decremented. In other words, one (1) year has passed or one (1) sub-period (does not necessarily have to be a year) has passed. At step 510, it is determined whether the remaining deferral period is greater than zero (0), subsequent to the decrement of step 508. If, at step 510, the deferral period is still greater than zero (0), then at step 512 the credit is refreshed. This can involve, for example, increasing the credit, decreasing the credit, or maintaining the credit at its current level. At step 514, it is determined whether the investor is still alive. This can be determined, for example, by an input to a computing device recorded in a memory, or by a computer search of records such as death records. If, at step 514 it is determined that the investor is still alive, then the process returns to step 506, where the credit is applied to the allocated assets and any ensuing growth (or loss) of the accumulated assets.

Returning to step 510, if it is determined that the deferral period is not greater than zero (0) (after being decremented at step 508), then the process goes to step 516, where the accumulated assets, which include the initially allocated assets plus (or minus) any investment growth (or losses), plus the credit growth of the investment are made available to the investor. The process then ends at step 520.

Returning to step 514, if it is determined that the investor is no longer alive (and the deferral period has not expired), then at step 518 all or part of the allocated assets plus any investment growth (or less any losses) plus all or parts of the credits are forfeited to an administrator of the longevity benefit. This forfeiture generally funds the operation of the longevity benefit and the survivorship credits that are applied. The process then ends at step 520.

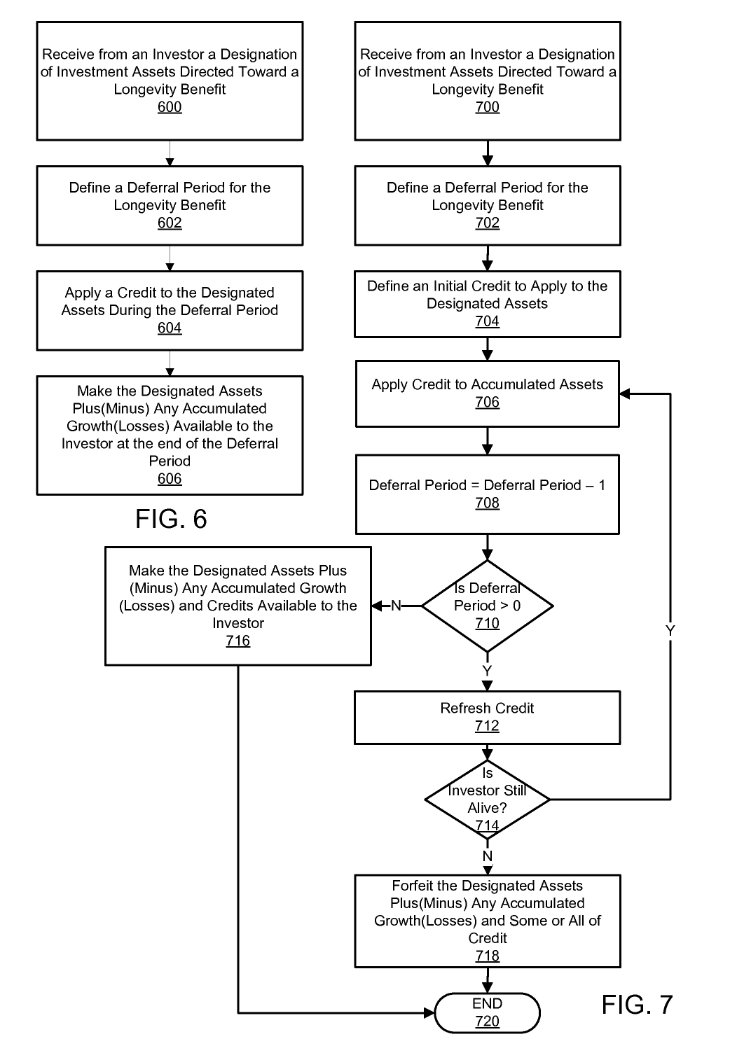

FIG. 6 is an illustration of an exemplary embodiment of a process that can be implemented and carried out on one or more computing devices such as those described in FIGS. 1-3. At step 600, an allocation of investment assets is designated toward a longevity benefit. The designation can be the transfer of assets to a distinct account, or designation of a portion of the assets of a new or existing account toward the longevity benefit. The designation of the assets, such as account number, account value, etc. can be stored in a memory associated with a computing device. At step 602, a deferral period is defined for the longevity benefit. For example, a 65 year old investor may desire a deferral period of twenty (20) years, so that the investor will have funds available at age eighty-five (85) if he or she survives to that age. Other deferral periods may be available and may be as short as one (1) year and as long as, for example, fifty (50) years. At step 604, a credit is applied to the allocated assets during the deferral period. The credit is above and beyond the investment return on the allocated assets from the underlying assets. For example, the credit can be a percentage of the allocated assets, or could even be a lump sum contributed to the allocated assets on a periodic or one-time basis during the deferral period. In one instance, for example, the credit increases each year of the deferral period. As an example, assume that the underlying investment allocated to the longevity benefit earns a ten percent (10%) annualized return—the credit could be an additional one-tenth of one percent (0.1%) in addition to the ten percent (10%) annualized return. In one aspect, the credit can escalate each year of the deferral period (e.g., one-tenth of one percent (0.1%) the first year, two-tenths of one percent (0.2%) the second year, three-tenths of one percent (0.3%) the third year, etc.). At step 606, at the end of the deferral period the accumulated assets, which include the initially allocated assets plus (or minus) any investment growth (or losses), plus the credit growth of the investment are made available to the investor. As previously described herein, the investor can receive these funds as a lump sum, a partial lump sum, on a periodic basis, as a payout annuity, etc.

FIG. 7 is an illustration of an exemplary embodiment of another process that can be implemented and carried out on one or more computing devices such as those shown and described in relation to FIGS. 1-3. At step 700, an allocation of investment assets is designated toward a longevity benefit. The designation can be the transfer of assets to a distinct account, or designation of a portion of the assets of a new or existing account toward the longevity benefit. The designation of the assets, such as account number, account value, etc. can be stored in a memory associated with a computing device. At step 702, a deferral period is defined for the longevity benefit. At step 704, an initial credit is defined for the allocated assets to be applied during the first year (or initial sub-period) of the deferral period. As previously described, the credit is above and beyond the investment return on the allocated assets from the underlying assets. At step 706, the credit is applied to the allocated assets and any ensuing growth (or loss) of the accumulated assets. At step 708, the deferral period is decremented. In other words, one (1) year has passed or one (1) sub-period (does not necessarily have to be a year) has passed. At step 710, it is determined whether the remaining deferral period is greater than zero (0), subsequent to the decrement of step 708. If, at step 710, the deferral period is still greater than zero (0), then at step 712 the credit is refreshed. This can involve, for example, increasing the credit, decreasing the credit, or maintaining the credit at its current level. At step 714, it is determined whether the investor is still alive. This can be determined, for example, by an input to a computing device recorded in a memory, or by a computer search of records such as death records. If, at step 714 it is determined that the investor is still alive, then the process returns to step 706, where the credit is applied to the allocated assets and any ensuing growth (or loss) of the accumulated assets.

Returning to step 710, if it is determined that the deferral period is not greater than zero (0) (after being decremented at step 708), then the process goes to step 716, where the accumulated assets, which include the initially allocated assets plus (or minus) any investment growth (or losses), plus the credit growth of the investment are made available to the investor. The process then ends at step 720.

Returning to step 714, if it is determined that the investor is no longer alive (and the deferral period has not expired), then at step 718 all or part of the allocated assets plus any investment growth (or less any losses) plus all or parts of the credits are forfeited to an administrator of the longevity benefit. This forfeiture generally funds the operation of the longevity benefit and the survivorship credits that are applied. The process then ends at step 720.

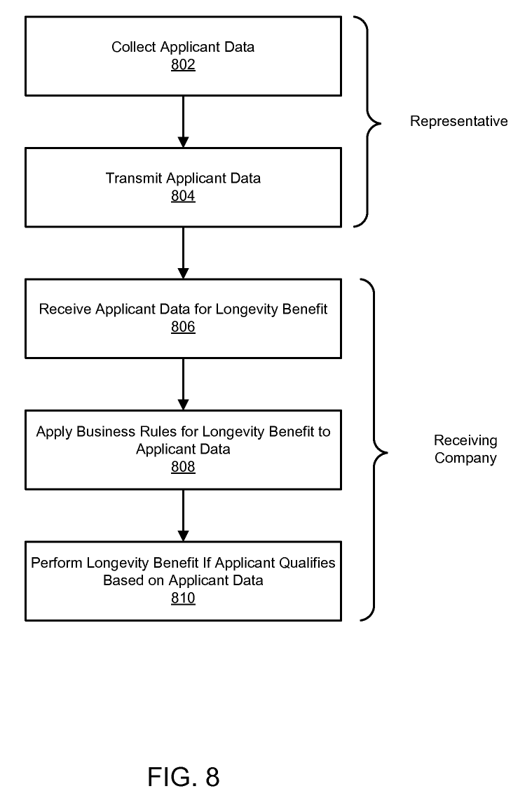

FIG. 8 illustrates the steps taken when issuing a longevity benefit according to one embodiment. As shown, in one embodiment the process of issuing a longevity benefit begins at step 802 in which a representative of the longevity benefit issuer collects applicant data 322 from a prospective investor and enters it into his or her computing device 308. In step 804, the applicant data 322 is transmitted from the computing device 308 to the receiving computer 312 using the application data processing module 322 on the computing device 308. The applicant data collected may include, for example, the information used to determine applicant's eligibility for the longevity benefit, which can include prospective investor's name, age, address or medical history, information about current investments, financial status, insurance coverage owned by the prospective policy participant, etc.

In other embodiments, the process could likewise begin with a prospective investor entering his or her own applicant data directly into an application form provided by the receiving company, and sending the application form to the receiving company. The application form could be in hard copy, requiring, for example, that the prospective investor enter the applicant data by hand, and then mail or fax the form to the receiving company. The applicant data could then be entered into the receiving computer 312 by, for example, a receiving company employee.

Alternatively, the application form could be provided over the Internet on a website operated by the receiving company, or by some other company affiliated with the receiving company. In this case, the prospective investor could merely enter the data into the online version of the application form and then send the data electronically to the receiving computer 312. In yet another embodiment, the prospective investor may contact a receiving company operator directly, by telephone or by other means, and communicate the applicant data to the operator, the data is then entered into the receiving computer 312 by the operator or another associated individual.

Once the receiving computer 312 has received the applicant data 322 in step 606, the receiving computer 312 stores the applicant data 322 in a database 318 on the receiving computer 312. The longevity benefit module 316 then applies business rules 324, which are also stored in the database 318 on the receiving computer 312, to the applicant data 322 to calculate the economic value of the longevity benefit based on one or more proposed investment amounts, deferral periods, and tax status, and to determine whether the prospective policy participant qualifies for the longevity benefit (step 808). This may include, for example, checking the applicant's name and address to determine whether they are valid, authenticating the applicant to ensure that the applicant is who he/she claims to be, determining whether the applicant is financially responsible based on a credit or payment history check, determining the applicant's medical history, determining parameters of the any underlying investment vehicle, determining whether the applicant is of legal age to enter a binding contract in the state in which a policy is sought, etc.

If the receiving computer 312 determines that the applicant is not qualified for the longevity benefit based on the applicant data 322 and business rules 324, then the receiving computer 312 rejects the application. Conversely, upon a determination by the receiving computer 312 that the prospective investor qualifies for the longevity benefit, in step 810 the receiving company issues the longevity benefit to the investor by, for example, generating benefit data 320 that is specific to the prospective investor including the allocated investments and amounts, deferral period, etc., storing the longevity benefit data 320 in the database 318, and transmitting the longevity benefit data 320 to the investor. The benefit data 320 can be sent, for example, electronically, by mail, by fax or delivered by hand, to the investor directly, or via the issuer's account representative.

### Longevity Benefit Examples

For example, a male investor, age sixty-five (65), is worried about living past or well beyond age eighty-five (85) (and out-living his retirement assets). He elects to designate a portion of his assets to contain a longevity benefit, as described herein. The investor chooses a deferral period of twenty (20) years (because he is concerned about having sufficient assets should he live past age eighty-five (85)). At the end of the deferral period, there is significantly greater growth in the investment with the longevity benefit, than without it (even when taxes are considered). As an example, depending upon the credit applied, assuming a return of eight percent (8%) on the underlying assets, the investor could have as much as twenty to sixty percent (20-60%) greater growth by age eighty-five (85). If the client had instead selected a deferral period of twenty-five (25) years, there could greater growth of as much as sixty to one-hundred percent (60-100%) by age ninety (90).

These values can be demonstrated using the following formulas:

Without Benefit: AVₜ=AVₜ₋₁×(1+Iₜ)

With Benefit: AVₜ=AVₜ₋₁×(1+Iₜ)×(1+Cₜ)

Where:
t=time period
AVₜ=Account Balance at time t (at the beginning, this is equal to the allocated assets)
Iₜ=investment growth of the underlying assets over the preceding time period (net of fees and taxes, if any)
Cₜ=credit at time t expressed as a percentage

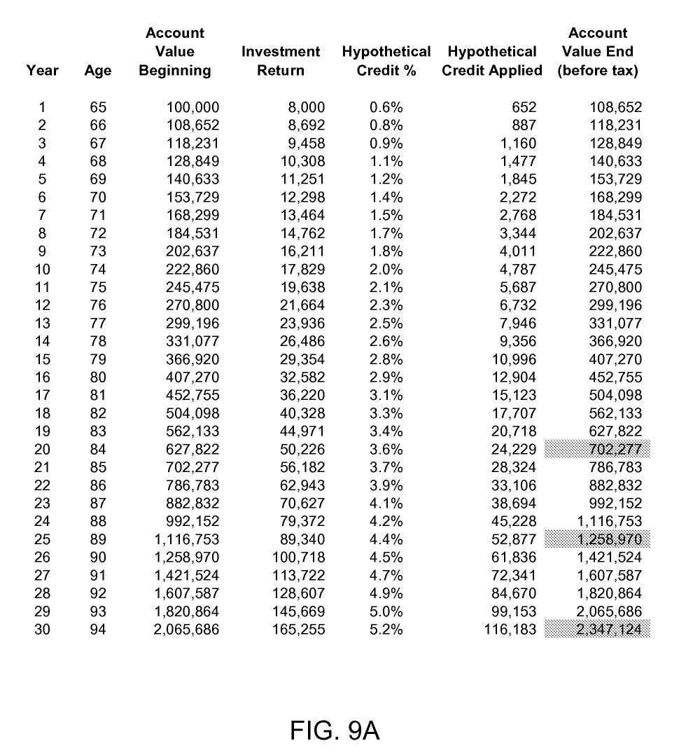

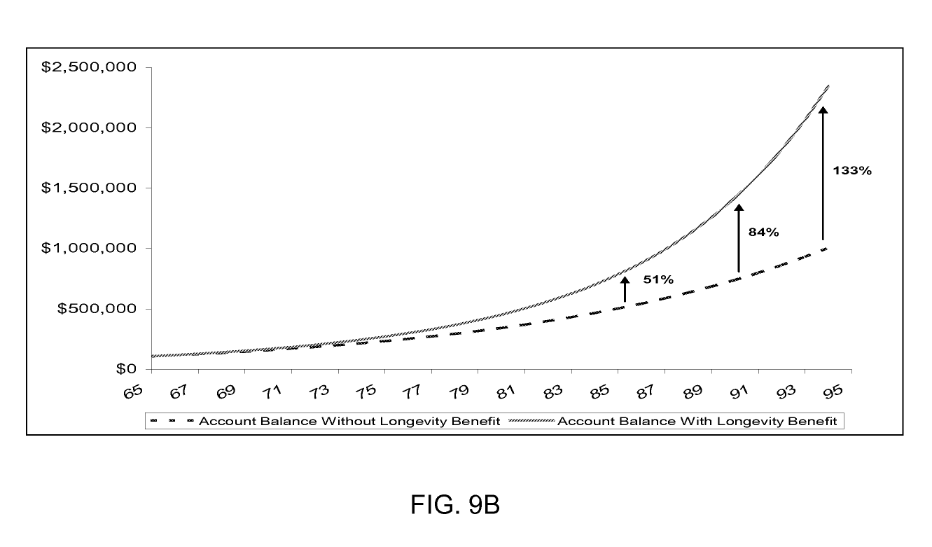

The growth of the investment with the longevity benefit is further illustrated in FIGS. 9A and 9B, using the same assumptions described above for the male investor, age sixty-five (65), and an assumed initial allocation of one-hundred thousand dollars ($100,000). FIG. 9A illustrates the growth with the credits in tabular form, and FIG. 9B illustrates the growth in graphical form. In this example and as shown in FIG. 9A, the credit started off at six-tenths of one percent (0.6%) and increased on an annual basis by approximately fifteen-hundredths of one percent (0.15%). Other credit values are contemplated within the scope of this invention, as well as a credit that comprises a periodic contribution (i.e., not a percentage) to the investment.

### Modifications and Alternative Embodiments

Although several aspects of the present invention have been disclosed in the foregoing specification, it is understood by those skilled in the art that many modifications and other aspects of the invention will come to mind to which the invention pertains, having the benefit of the teaching presented in the foregoing description and associated drawings. It is thus understood that the invention is not limited to the specific aspects disclosed hereinabove, and that many modifications and other aspects are intended to be included within the scope of the appended claims. Moreover, although specific terms are employed herein, as well as in the claims which follow, they are used only in a generic and descriptive sense, and not for the purposes of limiting the described invention.

What is claimed is:

1. A method for providing a longevity benefit to an investor, implemented on one or more computing devices, said method comprising:
allocating assets toward a longevity benefit;
defining a deferral period for the longevity benefit;
applying a credit on a periodic basis to the allocated assets during the deferral period;
determining accumulated assets at the end of each period of the deferral period, wherein said accumulated assets are comprised of the allocated assets plus (or minus) any investment growth (or losses) on the allocated assets, plus a summation of all the credits applied to the allocated assets on the periodic basis over the deferral period, plus (or minus) any investment growth (or losses) of the credits applied to the allocated assets on the periodic basis over the deferral period; and
making the accumulated assets available to the investor at the end of the deferral period.

2. The method of claim 1, wherein allocating assets toward a longevity benefit comprises liquidating all or a portion of investment assets and investing proceeds from the liquidated investment assets in a financial instrument.

3. The method of claim 2, wherein the financial instrument is an annuity.

4. The method of claim 2, wherein the financial instrument is one or more of money, stock, mutual funds shares, equity investments, financial assets, or combinations thereof.

5. The method of claim 1, wherein allocating assets toward the longevity benefit comprises investing assets in a financial instrument.

6. The method of claim 5, wherein the financial instrument is an annuity.

7. The method of claim 5, wherein the financial instrument is one or more of money, stock, mutual funds shares, equity investments, financial assets, or combinations thereof.

8. The method of claim 1, wherein applying a credit on a periodic basis to the allocated assets during the deferral period comprises applying a credit that escalates each period of the deferral period.

9. The method of claim 8, wherein the credit escalates by a pre-determined percentage each period of the deferral period.

10. The method of claim 1, wherein applying a credit on a periodic basis to the allocated assets during the deferral period comprises making a contribution to the allocated assets on the periodic basis.

11. The method of claim 10, wherein the contribution to the allocated assets is a contribution of one or more of money, stock, mutual funds shares, equity investments, financial assets, or combinations thereof.

12. The method of claim 1, wherein applying a credit on a periodic basis to the allocated assets during the deferral period comprises applying the credit on an annual basis.

13. The method of claim 1, wherein all or a portion of the accumulated assets are forfeited to an administering entity if the investor dies before the end of the deferral period.

14. The method of claim 1, wherein making the accumulated assets available to the investor at the end of the deferral period comprises survival of the investor to a designated age creating a guaranteed level of income to the investor irrespective of the accumulated assets at the end of the deferral period.

15. The method of claim 14, wherein survival of the investor to a designated age comprises survival of the investor to the age at the end of the deferral period or later.

16. The method of claim 1, wherein defining a deferral period for the longevity benefit comprises defining a deferral period of 50 years or less.

17. A system for providing a longevity benefit to an investor comprising:
a computer-readable media; and
a processor operably connected with said computer-readable media, wherein said processor is configured to;
receive and store asset information on said computer-readable media, wherein said asset information comprises information about an allocation of assets toward a longevity benefit;
receive and store asset information on said computer-readable media a deferral period for the longevity benefit;
apply a credit on a periodic basis to the allocated assets during the deferral period;
determine accumulated assets at an end of each period of the deferral period, wherein said accumulated assets are comprised of the allocated assets plus (or minus) any investment growth (or losses) on the allocated assets, plus a summation of all the credits applied to the allocated assets on the periodic basis over the deferral period, plus (or minus) any investment growth (or losses) of the credits applied to the allocated assets on the periodic basis over the deferral period; and
make the accumulated assets available to the investor at an end of the deferral period.

18. The system of claim 17, wherein the computer-readable media is a memory.

19. The system of claim 17, wherein receiving and storing asset information on said computer-readable media, wherein said asset information comprises information about an allocation of assets toward a longevity benefit comprises executing one or more transactions liquidating all or a portion of investment assets and investing proceeds from the liquidated investment assets in a financial instrument.

20. The system of claim 19, wherein the financial instrument is an annuity.

21. The system of claim 19, wherein the financial instrument is one or more of money, stock, mutual funds shares, equity investments, financial assets, or combinations thereof.

22. The system of claim 17, wherein receiving and storing asset information on said computer-readable media, wherein said asset information comprises information about an allocation of assets toward a longevity benefit comprises investing assets in a financial instrument.

23. The system of claim 22, wherein the financial instrument is an annuity.

24. The system of claim 22, wherein the financial instrument is one or more of money, stock, mutual funds shares, equity investments, financial assets, or combinations thereof.

25. The system of claim 17, wherein applying a credit on a periodic basis to the allocated assets during the deferral period comprises applying a credit that escalates each period of the deferral period.

26. The system of claim 25, wherein the credit escalates by a pre-determined percentage each period of the deferral period.

27. The system of claim 17, wherein applying a credit on a periodic basis to the allocated assets during the deferral period comprises making a contribution to the allocated assets on the periodic basis.

28. The system of claim 27, wherein the contribution to the allocated assets is a contribution of one or more of money, stock, mutual funds shares, equity investments, financial assets, or combinations thereof.

29. The system of claim 17, wherein applying a credit on a periodic basis to the allocated assets during the deferral period comprises applying the credit on an annual basis.

30. The system of claim 17, wherein all or a portion of the accumulated assets are forfeited to an administering entity if the investor dies before the end of the deferral period.

31. The system of claim 17, wherein making the accumulated assets available to the investor at the end of the deferral period comprises survival of the investor to a designated age creating a guaranteed level of income to the investor irrespective of the accumulated assets at the end of the deferral period.

32. The system of claim 31, wherein survival of the investor to a designated age comprises survival of the investor to the age at the end of the deferral period or later.

33. The system of claim 17, wherein defining a deferral period for the longevity benefit comprises defining a deferral period of 50 years or less.
